(19) United States
(12) Patent Application Publication
(10) Pub. No.: US 2026/0298095 A1
(43) Pub. Date: Oct. 1, 2026

(54) A HEAT SHIELD FOR A ROTOR OF A TURBO ENGINE

(71) Applicant: Siemens Energy Global GmbH & Co. KG, Munich, Bayern (DE)

(72) Inventors: Peter Schröder, Essen (DE); Karsten Kolk, Mülheim a.d. Ruhr (DE); Todd Ebert, West Palm Beach, FL (US); Stephen Williamson, McAdenville, NC (US); Alexandra Pajak, Neuss (DE); Junfen Qiu, Orlando, FL (US); Benjamin Bohl, Berlin (DE)

(73) Assignee: Siemens Energy Global GmbH & Co. KG, Munich, Bayern (DE)

(21) Appl. No.: 19/472,661

(22) PCT Filed: Apr. 2, 2024
(86) PCT No.: PCT/EP2024/058881

§ 371 Date: Oct. 4, 2025

Related U.S. Application Data
(60) Provisional application No. 63/497,219, filed on Apr. 20, 2023.

(51) Int. Cl. F01D 5/08

(52) U.S. Cl. CPC F01D 5/08; F05D 2260/201

(57) ABSTRACT

A heat shield for a rotor of a turbo engine, having a main body and at least one fastening element, wherein the main body, when the heat shield is assembled in its final assembly position on the rotor of the turbo engine and in relation to the rotational axis of said rotor, extends in an axial direction from a first axial end to a second axial end and in a circumferential direction from a first lateral end to a second lateral end, wherein the main body has at least one cooling channel, and a surface, on which, when assembled, faces inwardly to the rotor, the at least one fastening element is arranged for attaching the heat shield onto a post body of the rotor. For protecting post bodies of a rotor against massive heat input, the at least one cooling channel extends in axial direction for guiding a coolant accordingly.

### CROSS REFERENCE TO RELATED APPLICATIONS

This application is the US National Stage of International Application No. PCT/EP2024/058881 filed 2 Apr. 2024, and claims the benefit thereof, which is incorporated by reference herein in its entirety. The International Application claims the benefit of U.S. Provisional Application No. 63/497,219 filed 20 Apr. 2023.

### FIELD OF THE INVENTION

The invention relates to a heat shield for a rotor of a turbo engine.

### BACKGROUND TO THE INVENTION

The rotor of conventional gas turbines comprises usually several disks, which carries rotor blades in rows. Herewith their platforms form an inner boundary of a hot gas path of the gas turbine. As gaps are established between the platforms are, these are usually sealed to avoid that hot gas is leaving the gas path therethrough and is entering the areas beyond the inner boundaries. To reduce the risk of this hot gas leakage, it is known the feed blocking or cooling air from the reverse, i.e., colder side of said gaps having a higher pressure than the hot gas. In a turbine rotor, the reverse area next to said gaps is also known as rim cavities, as each of these empty volumes are radially inwardly bordered by the circumferential rim of the rotor disk. Further, the rim cavities are also bordered by shanks of the rotor blades, which monolithically connects the rotor blade roots with the rotor blade platforms. Such an arrangement is known from U.S. Pat. No. 8,128,365 B2.

As the blocking air can be heated up due to hot gas penetration and thermal radiation from the platforms, material bordering of the rim cavity might be heat up to an extent that is unfavorable for the lifetime of the affected parts.

In accordance with U.S. Pat. No. 8,128,365 B2, post bodies, between which rotor blades are mounted, can extents into the area directly underneath the platforms and comprises impingement cooling holes. By feeding cooling air through the disk and their post bodies directly underneath the platform of the rotor blades, the volume of the rim cavity is reduced and simultaneously the post bodies are cooled. Instead of a monolithic post body, it is also known to mount an impingement insert onto the rim of the rotor disk.

However, this arrangement requires a complex rotor disk and leads to an increase of cooling air consumption resulting and a reduced gas turbine efficiency. Further, these rather solid and enlarged post bodies increase the mechanical load onto the disks.

Besides this, it is known from US 2013/0108446 A1 to provide a self-supporting plug in the rim cavity, which fills out this volume substantially. The plug acts as replacement body for cooling air forcing the cooling air to flow directly next to the rim cavity surfaces. With that, the post bodies of the rotor disk can be cooled and protected against warming from heat appearing in the rim cavity and radiated from the platforms. The self-supporting assembly of the plug however puts additional centrifugal load onto the rotor blades, which is unfavorable.

Further, it is known from JP H04 301101 A to reduce the heat transfer to the turbine disk post and by providing a heat blocking shield and a low velocity air insulation layer between the disk post and blade platform.

Hence, an object of the present invention is to provide an alternative solution of a heat shield for a rotor of a turbo engine overcoming the drawbacks of the prior art.

### SUMMARY OF THE INVENTION

In order to solve the afore-mentioned problems, a heat shield according to the present invention has the features of the independent claims. Further preferable embodiments are mentioned in the dependent claims, whereby their features can be combined arbitrarily.

In detail the heat shield for a rotor of a turbo engine is proposed, which has at least one cooling channel extending in axial direction for guiding a coolant in axial direction.

Instead of a changing the secondary air system or providing cooler cooling or blocking air, which would decrease the disk metal temperature and turbo engine efficiency as well, the inventors propose to implement a lightweight heat shield in the rim cavity directly next to the rim of the rotor disk, such, that the heat shield acts as an internally cooled heat shield which protects the rim of the rotor disk against undesired heat flux into the rotor disk material. With that, the coolable heat shield is attached onto the rotor disk and especially on the top of each post body. The main function of the heat shield is to split the coolant into several streams and to reroute the coolant mass flow from radial to axial direction due by guiding the coolant directly through its interior and to the disk outer surface. Consequently, the heat shield is working as a protective shield so that the rotor disk is less heated up by the remaining coolant circulating in the rim cavity.

The advantages are given with the performance of the engine. The local temperatures of the post body material can be limited without the need to extract additional coolant flow or to increase its pressure, which both would reduce the overall turbo engine performance. With that, a higher lifetime of rotor disks can be achieved or a cheaper material for the rotor disk can be selected.

In accordance with a first preferred embodiment of the invention the main body is essentially hollow by the arrangement of multiple cooling channels, wherein the cooling channels are of a straight configuration, and each cooling channel extends from a first opening located on the first axial end to a second opening located on the second axial end of the heat shield. This allows for conditioning and controlling heat transfer by guiding coolant flow over the top of the rotor disk, whereas in the prior art the heat transfer was dominated by free convection.

According to a second preferred embodiment of the heat shield each fastening element is embodied as dovetail-shaped rail or a series of dovetail-shaped hooks. These types of attachment are easy to manufacture and reliable during operation.

In accordance with another preferred embodiment the heat shield comprises two fastening elements, the fastening elements have different axial lengths, or their front faces are arranged offset to each other. When assembled onto a rotor disk, and when the fastening element and/or the coolant guiding rib axially extends over one of the post body front surfaces, this feature of the heat shield enables the split of coolant being present lateral of the front face of the rotor disk into separate coolant flows. The separate coolant flows are guided along the fastening elements and directly next to the post body outer surface as the rotor rotates. The separate coolant flows are flowing along the axial direction. The coolant guiding ribs and/or the fastening elements on the underside of the heat shield in cooperation with the respective post body form one or more cooling ducts for creating a uniform axial flow, which provides a significant improvement in cooling effectiveness. Further, utilizing two fastening elements prevents the heat shield against bending due to centrifugal forces.

Preferably, on the inward facing surface of the heat shield, in particular between the two fastening elements, at least one axially extending coolant guiding rib, and/or a pin for stopping the axial assembly movement of the heat shield is arranged. This supports the creation of the separate coolant flow along the axial direction.

Regarding another preferred embodiment the respective fastening element comprises at least one, in particular, multiple cutouts to reduce the heat conductivity from the heat shield into the post bodies.

Preferably, on at least one of the two lateral ends of the main body an angel wing is located to reduce the gap to adjacent rotor blades and to enlarge the size of the heat shield.

Regarding another preferred embodiment, the heat shield, or more precise, its surface, which, when assembled, faces outwardly towards rotor blades, is free of openings which could supply coolant directly to the rotor blade or is free of cooling holes for impingement cooling of the rotor blade platform.

Preferably, the main body has a radial height and a circumferential width including respective angel wings, wherein an aspect ratio of the radial height to the circumferential width is in range between 0.1 and 0.8, especially in the range between 0.15 and 0.4.

In accordance with another preferred embodiment a rotor rim arrangement comprises a heat shield in accordance with the invention in the rim cavity, in particular, which fills out not more than the radially lower half of the rim cavity and which is attached to the respective post body, for protecting the post body against heat.

Preferably, the heat shield is attached to the post body by one or two form-locking sliding rail or hook connections.

An easy to manufacture and to assembly rotor rim arrangement is achieved, when in an outward facing surface of the post body at least one axially extending groove is arranged, in which the fastening element of the heat shield is radially fixed in a form-locking manner. Then, the axially extending groove has a corresponding shape to the rails or hooks, especially a dovetail shape.

According to another aspect of the present invention the heat shield element is secured against relative axial movement in relation to the post body by a blocking element, which engages into a slot being arranged in the fastening element.

Of course, the interior of the heat shield can be designed differently. Its interior should support its stability against centrifugal forces and guide coolant through different channels by implementing a kind of lattice structure, stiffeners, honeycombs, bores, or the like. Depending on its complexity, the heat shield can be conventionally machined, or additively manufactured, especially by Laser Powder Bed Fusion.

### BRIEF DESCRIPTION OF THE DRAWINGS

Further advantages and features of the invention will be apparent from the following description based on the drawings. Thereby showing:

FIG. 1 schematically a gas turbine,

FIG. 2 a first exemplary embodiment of a heat shield for a rotor in a perspective view,

FIG. 3 a first exemplary embodiment of a rotor rim arrangement in a perspective view,

FIG. 4 a detail of the rotor rim arrangement in accordance with FIG. 3,

FIG. 5 a second exemplary embodiment of a rotor rim arrangement in a combined perspective and cross-sectional view, and

FIGS. 6-8 schematic cross-sections of further exemplary embodiments of a heat shield.

### DETAILED DESCRIPTION OF EMBODIMENTS

Multiple exemplary embodiments according to the present invention will be described below with reference to the drawings. In all drawings, the same features are provided with same reference signs.

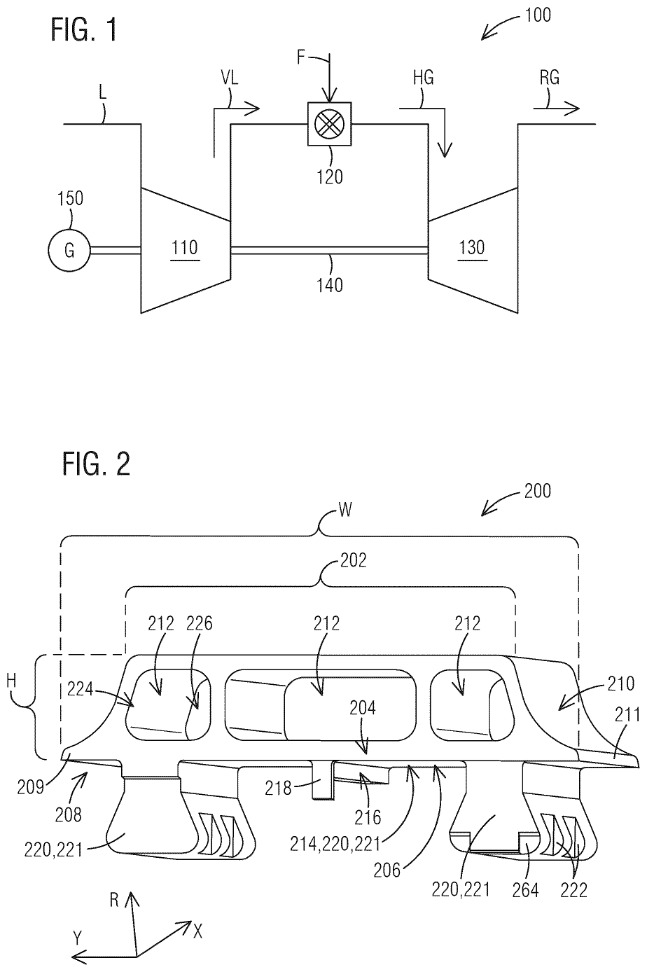

FIG. 1 shows schematically a gas turbine 100 as a specific embodiment of a turbo engine. The gas turbine 100 with a compressor 110, a combustion chamber 120 and a turbine unit 130. According to this exemplary embodiment, an electrical generator 150 for generating electricity is coupled to a rotor 140 of the gas turbine. During Operation ambient air AA is sucked in by the axial compressor 110. The ambient air is conveyed through the compressor while getting compressed along the way. The compressed air VL is then mixed with a fuel F in the combustion chamber 120 and burned to a hot gas HG. The hot gas HG expanded in the turbine unit 130 and leaves it as flue gas RG. The expansion of the hot gas HG generates torque in the turbine unit 130 onto the rotor 140, which then drives the compressor 110 and the electrical generator 150.

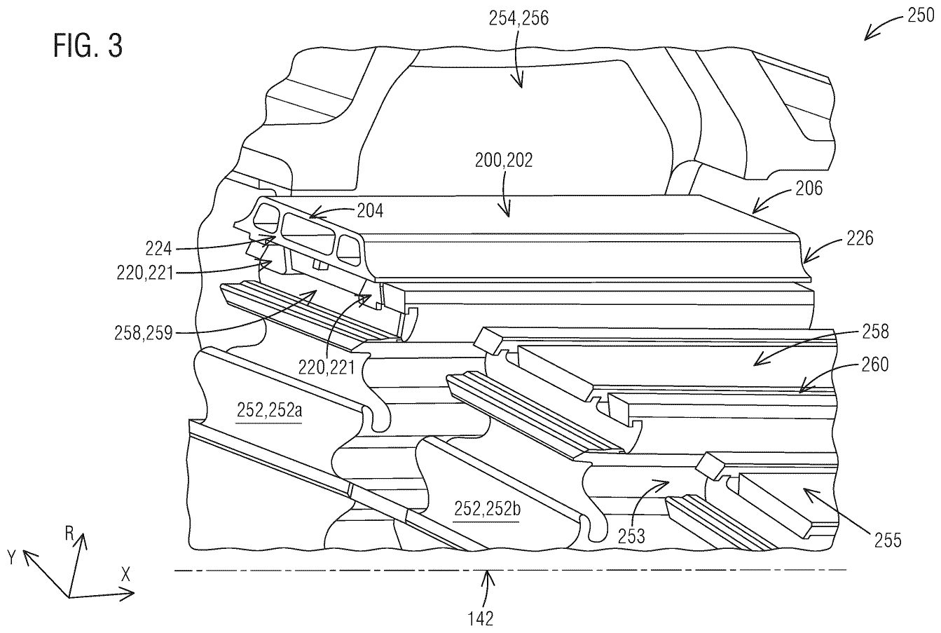

FIG. 2 shows a heat shield 200 for a rotor rim arrangement 250 (FIGS. 3-5). The heat shield 200 can be understood as coolant box and has a hollow main body 202. When the heat shield 200 is assembled on the rotor 140 of the gas turbine, especially on one of its rotor disks 251, the main body 202 extends in axial direction X from the first axial end 204 to a second axial end 206 and in circumferential direction Y from its first lateral end 208 to its second lateral end 210. The first axial end 204 is the upstream end and the second axial end 206 is the downstream end, in reference to the flow direction of the working medium in the hot gas path of the gas turbine.

The main body 202 comprises in radial direction R a height H and in circumferential direction Y a width W. The aspect ratio H/W of height H to width W is preferably in the range between 0.1 and 0.8 to provide a flat shaped and lightweighted main body 202. One preferred embodiment has an aspect ratio of 0.25.

In the interior of the main body 202 three cooling channels 212 extends parallel in axial direction X and are separated by internal ribs. Each cooling channel 212 has a first opening 224 and a second opening 226, each located at one of the two axial ends 204, 206.

The main body 202 has an inward facing surface 214, from which two fastening elements 220 and a pin 218 protrude. Between the two fastening elements 220 an axially extending rib coolant guiding rib 216 is arranged. It is possible that the rib 216 merges with the pin 218. Angel wings 209, 211 are foreseen as well on each of its first and second lateral ends 208 and 210 to enlarge the size of the heat shield and to reduce the sizes of the gaps towards the shanks of rotor blades.

For the sake of clarity it is mentioned that the terms “inward” and “outward” have to be understood with reference to the radial direction and the rotational axis 142.

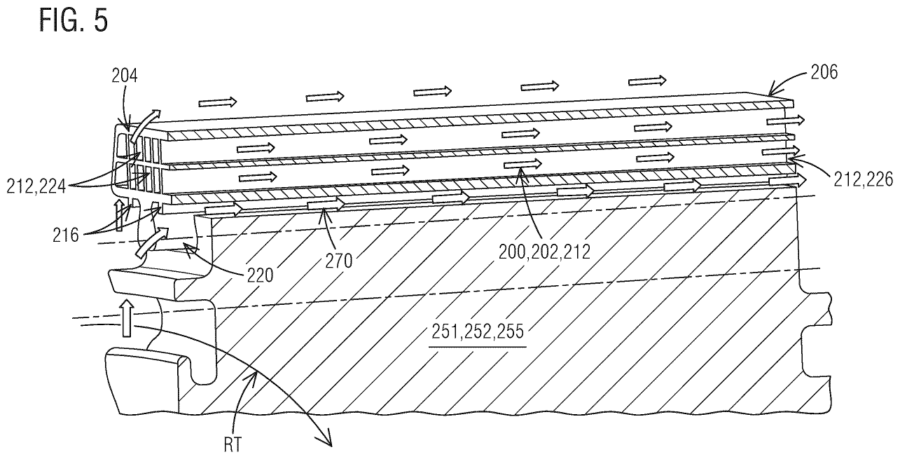

According to the exemplary embodiment shown in FIG. 2, each fasting element 220 is embodied as a dovetail-shaped rail. Cutouts 222 can decrease the size of the inclined surfaces, which, when assembled, are in contact directly with the rotor disk 251. A slot 264 extending through the rail in circumferential direction through which a blocking element 262 (FIG. 5) can extend trough.

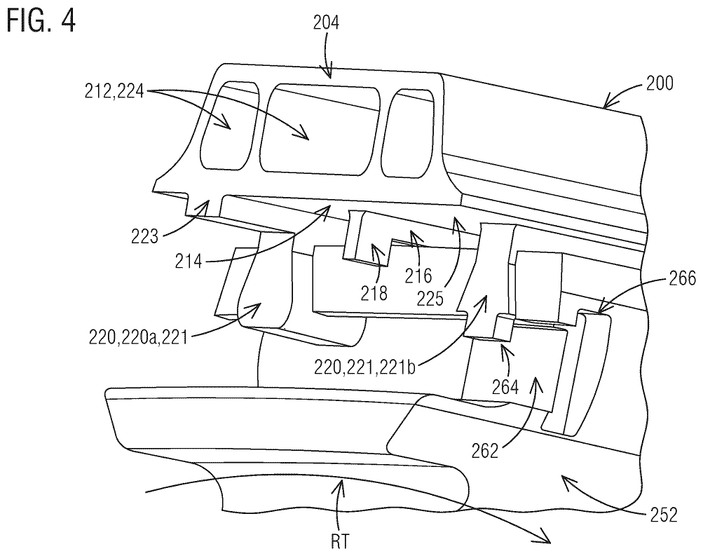

FIG. 3 shows a first exemplary embodiment of a rotor rim arrangement 250 in a perspective view and in FIG. 4 in more detail. The rotor rim arrangement 250 comprises a rotor disk 251. A rim 255 of the rotor disk comprises in an alternating way a serious of circumferentially post bodies 252 and mounting grooves 253 for rotor blades 254. In FIG. 3 two mounting grooves 253 are empty and only in the one (253) displayed in the very left a turbine blade 254 is already assembled.

The rotor blade 254 is conventional and comprises in sequence along the radial direction R a root, a shank, a platform, and an airfoil (not shown). Two post bodies 252 are shown, from which the one displayed on the left-hand side (252a) carries a heat shield 200 and the one on the right-hand side (252b) not. The top of the post bodies 252 ends in a flat outward facing surface 258, in which two grooves 260 are machined. The shape of the grooves 260 corresponds to shape of the fastening elements 220, e.g., rails, such that the heat shield 200 can be mounted to the rotor disk 251 by sliding in its rails into the grooves 260.

As seen best in FIG. 4, the two fastening elements 220 have different axial length as their front faces 221 are offset to each other. With that, the one fastening element 220a protrudes over a front face 259 of the post body 252, also on a stepwise manner considering the basis 223 of the rail. The pin 218 acts a blocking feature to limit the axial movement of the heat shield in the assembly direction. A blocking element 262 is assembled onto the rotor disk 251 and engages simultaneously both the slot 264 and an additional groove 266 for blocking any axial movement of the heat shield 200 when installed in its final position.

FIG. 5 shows a second exemplary embodiment of a rotor rim arrangement 250 in a combined perspective and cross-sectional view, wherein the same features are referenced by the same reference numbers.

In difference to the first embodiment shown in FIGS. 3 and 4, the heat shield 200 according to the second exemplary embodiment is attached on the post body by only a single fasting element 220, which is located in the middle between two coolant flow guiding ribs 216. Also, the number of cooling channels 212 differs from the first embodiment, since the shown lattice structure separates the interior of the heat shield 200 in more than three axially extending cooling channels 212.

During operation of the turbine engine equipped with one of the rotor rim arrangement 250 described herein, its rotor rotates in direction RT as indicated by the arrows in FIGS. 4 and 5. The coolant being present next to the front face of the rotor disk 251 is forced by centrifugal forces and pressure drop to flow radially. The extensions of the coolant guiding ribs 216, the protrusion 218 as well as the extension of the fastening elements 220 and/or their basis 223, captures the coolant 270 and guides it through the duct(s) located between the inward facing surface 214 of the heat shield 200 and the outward facing surface 258 of the post body 252. Also, by aid of the pressure difference on the upstream side and the downstream side of the rotor disk 251 the coolant 270 is flowing through the cooling channels 212 in the interior of the heat shield 200 along the axial direction to from the first openings 224 to the second openings 226 while cooling and shielding the post bodies 252 against undesired heat input.

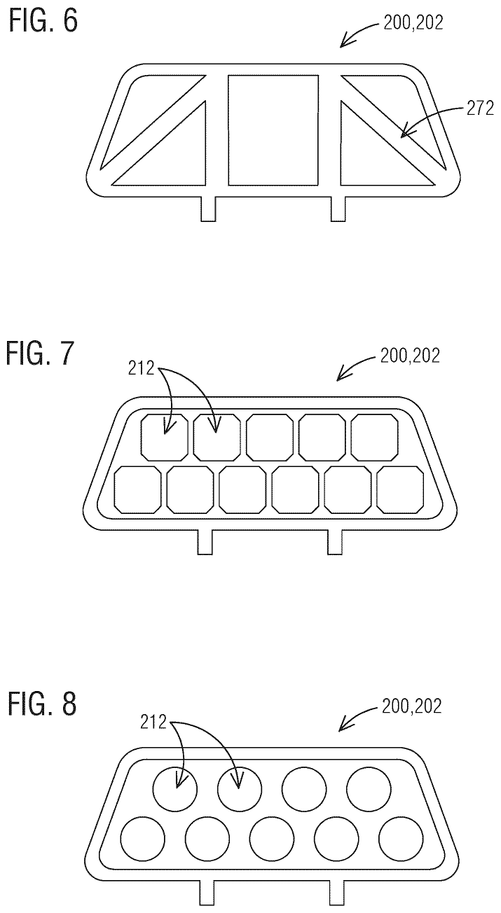

In accordance with FIG. 6-8 and shown therein only schematically, the main body 202 of the heat shield 200 and especially the axial cooling channels 212 can be embodied in different structures. Either several stiffening ribs 272 are in the main body 202 as shown in FIG. 6, or honeycombs as shown in FIG. 7. In an alternative structure, bore holes are present in the main body 202 for creating the axially extending coolant channels 212 of the heat shield 200. The latter is shown in FIG. 8.

1. A heat shield for a rotor of a turbo engine, comprising:
a main body and at least one fastening element wherein the main body when the heat shield is assembled in its final assembly position on the rotor of the turbo engine and in relation to the a rotational axis of said rotor, extends in an axial direction (X) from a first axial end to a second axial end and in a circumferential direction (Y) from a first lateral end (208) to a second lateral end,
wherein the main body comprises
at least one cooling channel and
a surface on which, when assembled, faces inwardly to the rotor, the at least one fastening element is arranged for attaching the heat shield onto a post body of the rotor
wherein the at least one cooling channel extends in axial direction (A) for guiding a coolant accordingly.

2. The heat shield according to claim 1,
wherein the main body is essentially hollow by an arrangement of multiple cooling channels,
wherein the cooling channels are of a straight configuration, and each cooling channel extends from a first opening located on the first axial end to a second opening located on the second axial end of the heat shield.

3. The heat shield according to claim 1,
wherein each fastening element is embodied as dovetail-shaped rail or a series of dovetail-shaped hooks.

4. The heat shield according to claim 3,
wherein the heat shield comprises two fastening elements, the fastening elements have different axial lengths, or their front faces are arranged offset to each other.

5. The heat shield according to claim 3,
wherein the respective fastening element comprises at least one cutout to reduce the heat conductivity.

6. The heat shield according to claim 1,
wherein on the surface at least one axially extending coolant guiding rib, and/or a pin for stopping axial assembly movement of the heat shield is arranged.

7. The heat shield according to claim 1,
wherein on at least one of the two lateral ends an angel wing is located to reduce a gap to adjacent rotor blades.

8. The heat shield according to claim 1,
wherein the heat shield is free of openings which supply coolant directly to a rotor blade.

9. The heat shield according to claim 1,
wherein the main body has a radial height and a circumferential width including respective angel wings,
wherein an aspect ratio of the radial height (H) to the circumferential width (W) is in range between 0.1 and 0.8.

10. A rotor rim arrangement for a rotor of a turbo engine, comprising:
a rotor disk having at its rim a number of post bodies arranged between a number of rotor blade mounting grooves each extending in axial direction (X) through the rim,
a number of rotor blades, each comprising successively a rotor blade root, a shank, a platform, and an airfoil,
wherein each of the rotor blade roots is located in a form fitting manner in one of the rotor blade mounting grooves, such, that an identical number of rim cavities are established,
each of the respective rim cavities is—in relation to a rotation axis of the rotor of the turbo engine—radially and circumferentially limited by two adjacent rotor blades and an outward facing surface of the post body located between the respective rotor blade roots,
wherein, for protecting the post bodies against radially heat input into each post body, the heat shield in accordance with claim 1 is located in the respective rim cavity and attached to the respective post body by the at least one fastening element, such that one or more ducts are located between an inward facing surface of the heat shield and the outward facing surface of the post body.

11. The rotor rim arrangement according to claim 10,
wherein the heat shield is attached to the post body by two form-locking sliding rail or hook connections.

12. The rotor rim arrangement according to claim 10,
wherein in an outward facing surface of the post body, at least one axially extending groove is arranged, in which the fastening element of the heat shield is radially secured in a form-locking manner.

13. The rotor rim arrangement according to claim 10,
wherein the heat shield, the fastening element and/or a coolant guiding rib axially extends over one of the post body front surfaces.

14. The rotor rim arrangement according to claim 10,
wherein the heat shield is secured against relative axial movement in relation to the post body by a blocking element, which engages into a slot located in the fastening element (220).

15. The heat shield according to claim 5,
wherein the respective fastening element comprises multiple cutouts to reduce the heat conductivity.

16. The heat shield according to claim 6,
wherein on the surface, between two fastening elements, at least one axially extending coolant guiding rib, and/or a pin for stopping axial assembly movement of the heat shield is arranged.

17. The heat shield according to claim 8,
wherein the heat shield is free of impingement cooling holes for cooling a platform of a rotor blade, in the surface of the heat shield, which, when assembled, faces outwardly towards rotor blades.

18. The heat shield according to claim 9,
wherein an aspect ratio of the radial height (H) to the circumferential width (W) is in range between 0.15 and 0.4.

19. The rotor rim arrangement of claim 10,
wherein the heat shield is located in the respective rim cavity only in a radially lower half.
